(19) United States
(12) Patent Application Publication
(10) Pub. No.: US 2009/0195220 A1
(43) Pub. Date: Aug. 6, 2009

(54) RECOVERABLE ULTRACAPACITOR ELECTRODE

(76) Inventors: Linda Zhong, San Diego, CA (US); Xiaomei Xi, Carlsbad, CA (US)

Correspondence Address: Maxwell Technologies, Inc., 9244 Balboa Avenue, San Diego, CA, 92123, US

(21) Appl. No.: 12/027,200

(22) Filed: Feb. 6, 2008

(51) Int. Cl. H02J 7/00

(52) U.S. Cl. 320/166

(57) ABSTRACT

An exemplar method of recovering a capacitance level of a double layer capacitor is disclosed. Further implementations describe making electrodes and double layer capacitors that provide a recovery of capacitance after that capacitor has undergone a fade in capacitance. In one implementation, for example, methods of treating a double layer capacitor are provided that allow for recovery of capacitance in the double layer capacitor. In these methods, capacitance of the double layer capacitor may be recovered after it has faded. After a double layer capacitor has experienced capacitance fade, the double layer capacitor may be rested in an unloaded condition and/or heated to recover at least a portion of its lost capacitance. Recovering faded capacitance both increases the energy storage capacity available during each charge/discharge cycle of the capacitor and increases the useful life of the double layer capacitor by delaying the capacitance fade below a particular level that is deemed a failure for a particular application.

### FIELD OF THE INVENTION

The present invention generally relates to double layer capacitors. More specifically, the present invention relates methods for recovering capacitance of a double layer capacitor.

### BACKGROUND

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, equivalent series resistance (ESR), and/or durability, i.e., the ability to withstand multiple charge-discharge cycles. For a number of reasons, double layer capacitors, also known as supercapacitors and ultracapacitors, are gaining popularity in many energy storage applications. The reasons include availability of double layer capacitors with high power densities (in both charge and discharge modes), and with energy densities approaching those of conventional rechargeable cells.

Double layer capacitors typically use as their energy storage element electrodes immersed in an electrolyte (an electrolytic solution). As such, a porous separator immersed in and impregnated with the electrolyte may ensure that the electrodes do not come in contact with each other, preventing electronic current flow directly between the electrodes. At the same time, the porous separator allows ionic currents to flow through the electrolyte between the electrodes in both directions. As discussed below, double layers of charges are formed at the interfaces between the solid electrodes and the electrolyte.

When electric potential is applied between a pair of electrodes of a double layer capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the double layer capacitors through orientation and alignment of molecules of the electrolytic solution under influence of the electric field induced by the potential. This mode of energy storage, however, is secondary.

In comparison to conventional capacitors, double layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight. High capacitance of double layer capacitors allows the capacitors to receive, store, and release large amount of electrical energy.

Electrical energy stored in a capacitor is determined using a well-known formula:

$$E = \frac{C * {V}^{2}}{2} . \qquad ( 1 )$$

In this formula, E represents the stored energy, C stands for the capacitance, and V is the voltage of the charged capacitor. Thus, the maximum energy (Eₘ) that can be stored in a capacitor is given by the following expression:

$${E}_{m} = \frac{C * {V}_{r}^{2}}{2} , \qquad ( 2 )$$

where Vᵣ stands for the rated voltage of the capacitor. It follows that a capacitor's energy storage capability depends on both (1) its capacitance, and (2) its rated voltage. Increasing these two parameters may therefore be important to capacitor performance. Indeed, the total energy storage capacity varies linearly with capacitance and as a second order of the voltage rating.

Double layer capacitors typically undergo a process known as capacitance fade during which a capacitance of a double layer capacitor drops as the capacitor undergoes repeated charge/discharge cycles. Since the capacitance of the double layer capacitor is the energy storage capacity of the double layer capacitor, a degradation in the capacitance of the cell decreases the energy capacity that may be stored in the capacitor during each successive charge/discharge cycle. Further, once the capacitance of a double layer capacitor has decreased beyond a certain point, the capacitor may be deemed to have failed for a particular application. In some applications, for example, a capacitance fade of 30% or more may be deemed a failed capacitor.

The rate of capacitance fade for a particular double layer capacitor may be reduced by using high purity materials in the construction of the capacitor. A double layer capacitor may, for example, be constructed from high purity carbon, electrolyte, packaging materials (e.g., aluminum). In addition, processing steps used in the manufacture of double layer capacitor cells can be used to minimize or eliminate the introduction of impurities introduced into a double layer capacitor during its construction. While these steps can be used to reduce capacitance fade, such materials and processing operations are very expensive and greatly increases the costs of the double layer capacitors produced that way.

### SUMMARY

Various implementations hereof are directed to methods, electrodes, electrode assemblies, and electrical devices that may be directed to or may satisfy a need for capacitance recovery in a double layer capacitor. An exemplar implementation herein disclosed is a method of recovering a capacitance level of a double layer capacitor. Further implementations describe making electrodes and double layer capacitors that provide a recovery of capacitance after that capacitor has undergone a fade in capacitance.

In one implementation, for example, methods of treating a double layer capacitor are provided that allow for recovery of capacitance in the double layer capacitor. In these methods, capacitance of the double layer capacitor may be recovered after it has faded. After a double layer capacitor has experienced capacitance fade, the double layer capacitor may be rested in an unloaded condition and/or heated to recover at least a portion of its lost capacitance. Recovering faded capacitance both increases the energy storage capacity available during each charge/discharge cycle of the capacitor and increases the useful life of the double layer capacitor by delaying the capacitance fade below a particular level that is deemed a failure for a particular application.

These and other features and aspects of the present invention will be better understood with reference to the following description, drawings, and appended claims.

### BRIEF DESCRIPTION OF THE DRAWINGS

FIG. 1 illustrates selected operations of a process for making active electrode material in accordance with some aspects hereof; and

FIG. 2, which includes sub-part FIGS. 2A and 2B, illustrates a cross-section of respective electrode assemblies which may be used in an ultracapacitor.

FIG. 3 illustrates a flow chart of an example process of recovering a capacitance level of a capacitor that has undergone a capacitance fade.

FIG. 4 illustrates a graph showing capacitance changes for a double layer capacitor.

FIG. 5 illustrates a graph showing capacitance changes for another double layer capacitor.

FIG. 6 illustrates a graph showing capacitance changes for yet another double layer capacitor.

### DETAILED DESCRIPTION

In this document, the words “implementation” and “variant” may be used to refer to a particular apparatus, process, or article of manufacture, and not necessarily always to one and the same apparatus, process, or article of manufacture. Thus, “one implementation” (or a similar expression) used in one place or context can refer to one particular apparatus, process, or article of manufacture; and, the same or a similar expression in a different place can refer either to the same or to a different apparatus, process, or article of manufacture. Similarly, “some implementations,” “certain implementations,” or similar expressions used in one place or context may refer to one or more particular apparatuses, processes, or articles of manufacture; the same or similar expressions in a different place or context may refer to the same or a different apparatus, process, or article of manufacture. The expression “alternative implementation” and similar phrases are used to indicate one of a number of different possible implementations. The number of possible implementations is not necessarily limited to two or any other quantity. Characterization of an implementation as “an exemplar” or “exemplary” means that the implementation is used as an example. Such characterization does not necessarily mean that the implementation is a preferred implementation; the implementation may but need not be a currently preferred implementation.

The expression “active electrode material” and similar phrases signify material that provides or enhances the function of the electrode beyond simply providing a contact or reactive area approximately the size of the visible external surface of the electrode. In a double layer capacitor electrode, for example, a film of active electrode material includes particles with high porosity, so that the surface area of the electrode exposed to an electrolyte in which the electrode is immersed may be increased well beyond the area of the visible external surface; in effect, the surface area exposed to the electrolyte becomes a function of the volume of the film made from the active electrode material.

The meaning of the word “film” is similar to the meaning of the words “layer” and “sheet”; the word “film” does not necessarily imply a particular thickness or thinness of the material. When used to describe making of active electrode material film, the terms “powder,” “particles,” and the like refer to a plurality of small granules. As a person skilled in the art would recognize, particulate material is often referred to as a powder, grain, specks, dust, or by other appellations. References to carbon and binder powders throughout this document are thus not meant to limit the present implementations.

The references to “binder” within this document are intended to convey the meaning of polymers, co-polymers, and similar ultra-high molecular weight substances capable of providing a binding for the carbon herein. Such substances are often employed as binder for promoting cohesion in loosely-assembled particulate materials, i.e., active filler materials that perform some useful function in a particular application.

The words “calender,” “nip,” “laminator,” and similar expressions mean a device adapted for pressing and compressing. Pressing may be, but is not necessarily, performed using rollers. When used as verbs, “calender” and “laminate” mean processing in a press, which may, but need not, include rollers. Mixing or blending as used herein may mean processing which involves bringing together component elements into a mixture. High shear or high impact forces may be, but are not necessarily, used for such mixing. Example equipment that can be used to prepare/mix the dry powder(s) hereof may include, in non-limiting fashion: a ball mill, an electromagnetic ball mill, a disk mill, a pin mill, a high-energy impact mill, a fluid energy impact mill, an opposing nozzle jet mill, a fluidized bed jet mill, a hammer mill, a fritz mill, a Warring blender, a roll mill, a mechanofusion processor (e.g., a Hosokawa AMS), or an impact mill.

Other and further definitions and clarifications of definitions may be found throughout this document. The definitions are intended to assist in understanding this disclosure and the appended claims, but the scope and spirit of the invention should not be construed as strictly limited to the definitions, or to the particular examples described in this specification.

Reference will now be made in detail to several implementations of the invention that are illustrated in the accompanying drawings. The same reference numerals are used in the drawings and the description to refer to the same or substantially the same parts or operations. The drawings are in simplified form and not to precise scale. For purposes of convenience and clarity only, directional terms, such as top, bottom, left, right, up, down, over, above, below, beneath, rear, and front may be used with respect to the accompanying drawings. These and similar directional terms, should not be construed to limit the scope of the invention.

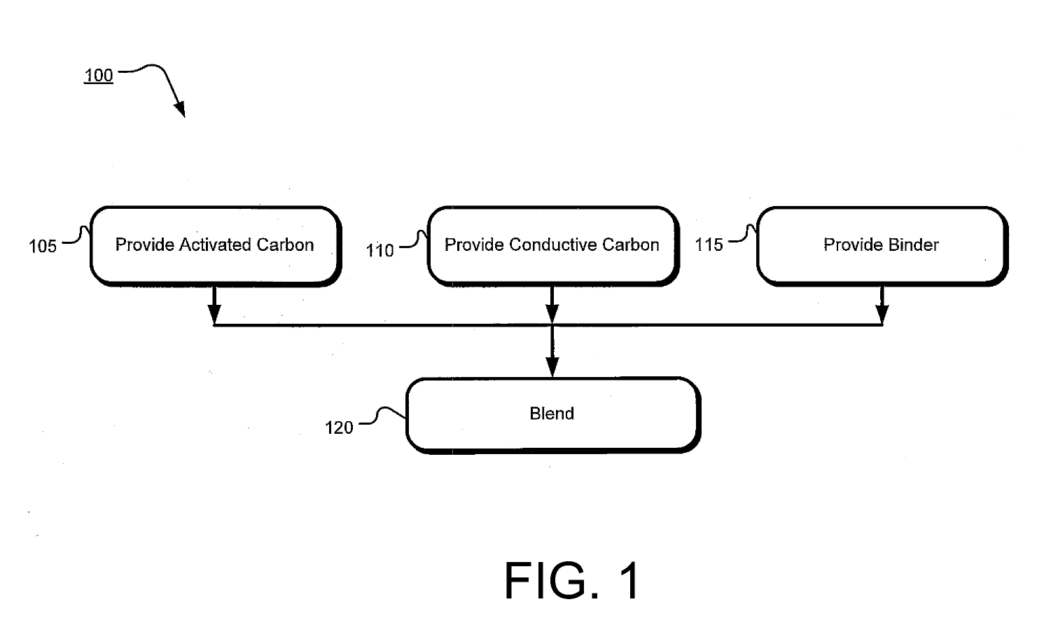

Referring more particularly to the drawings, FIG. 1 illustrates selected operations of a dry process 100 for making active electrode material. Although the process operations are described substantially serially, certain operations may also be performed in alternative order, in conjunction or in parallel, in a pipelined manner, or otherwise. There is no particular requirement that the operations be performed in the same order in which this description lists them, except where explicitly so indicated, otherwise made clear from the context, or inherently required. Not all illustrated operations may be strictly necessary, while other optional operations may be added to the process 100. A high level overview of the process 100 is provided immediately below. A more detailed description of the operations of the process 100 and variants of the operations are provided following the overview.

In operation 105, activated carbon particles may be provided. In operation 110, optional conductive carbon particles may be provided. In operation 115, binder may be provided. In one or more implementations, and although one or more of a variety of binders may be used as described elsewhere herein, the binder may include polytetrafluoroethylene (also known as PTFE or by the tradename, “Teflon®”). In operation 120, one or more of the activated carbon, conductive carbon, and binder may be blended or mixed; typically two or more may be mixed together. Alternatively, in certain implementations one or more of these ingredients and/or operations may be omitted.

In operation 115, binders may be provided, for example: PTFE in granular powder form, and/or various fluoropolymer particles, polypropylene, polyethylene, co-polymers, and/or other polymer blends. It has been identified, that the use of inert binders such as PTFE, tends to increase the voltage at which an electrode including such an inert binder may be operated. Such increase occurs in part due to reduced interactions with electrolyte in which the electrode is subsequently immersed. In one implementation, typical diameters of the PTFE particles may be in the five hundred micron range.

In the operation 120, activated carbon particles and binder particles may be blended or otherwise mixed together. In various implementations, proportions of activated carbon and binder may be as follows: about 80 to about 97 percent by weight of activated carbon, about 3 to about 20 percent by weight of PTFE. Optional conductive carbon could be added in a range of about 0 to about 15 percent by weight. An implementation may contain about 89.5 percent of activated carbon, about 10 percent of PTFE, and about 0.5 percent of conductive carbon. Other ranges are within the scope hereof as well. Note that all percentages are here presented by weight, though other percentages with other bases may be used. Conductive carbon may be preferably held to a low percentage of the mixture because an increased proportion of conductive carbon may tend to lower the breakdown voltage of electrolyte in which an electrode made from the conductive carbon particles is subsequently immersed (alternative electrolyte examples are set forth below).

In an implementation of the process 100, the blending operation 120 may be a “dry-blending” operation, i.e., blending of activated carbon, conductive carbon, and/or binder is performed without the addition of any solvents, liquids, processing aids, or the like to the particle mixture. Dry-blending may be carried out, for example, for about 1 to about 10 minutes in a mill, mixer or blender (such as a V-blender equipped with a high intensity mixing bar, or other alternative equipment as described further below), until a uniform dry mixture is formed. Those skilled in the art will identify, after perusal of this document, that blending time can vary based on batch size, materials, particle size, densities, as well as other properties, and yet remain within the scope hereof.

As introduced above, the blended dry powder material may also or alternatively be formed/mixed/blended using other equipment. Such equipment that can be used to prepare/mix the dry powder(s) hereof may include, for non-limiting examples: blenders of many sorts including rolling blenders and warring blenders, and mills of many sorts including ball mills, electromagnetic ball mills, disk mills, pin mills, high-energy impact mills, fluid energy impact mills, opposing nozzle jet mills, fluidized bed jet mills, hammer mills, fritz mills, roll mills, mechanofusion processing (e.g., a Hosokawa AMS), or impact mills. The blenders or mills, for example, may include conventional stainless steel liners or specialized ceramic or other liners having a high surface hardness. In an implementation, the dry powder material may be dry mixed using non-lubricated high-shear or high impact force techniques. In an implementation, high-shear or high impact forces may be provided by a mill such as one of those described above. The dry powder material may be introduced into the mill, wherein high-velocities and/or high forces could then be directed at or imposed upon the dry powder material to effectuate application of high shear or high impact to the binder within the dry powder material. The shear or impact forces that arise during the dry mixing process may physically affect the binder, causing the binder to bind the binder to and/or with other particles within the material.

Moreover, although additives, such as solvents, liquids, and the like, are not necessarily used in the manufacture of certain implementations disclosed herein, a certain amount of impurity, for example, moisture, may be absorbed by the active electrode material from the surrounding environment. Those skilled in the art will understand, after perusal of this document, that the dry particles used with implementations and processes disclosed herein may also, prior to being provided by particle manufacturers as dry particles, have themselves been pre-processed with additives and, thus, contain one or more pre-process residues. For these reasons, one or more of the implementations and processes disclosed herein may utilize a drying operation at some point before a final electrolyte impregnation operation, so as to remove or reduce the aforementioned pre-process residues and impurities. Even after one or more drying operations, trace amounts of moisture, residues and impurities may be present in the active electrode material and an electrode film made therefrom.

A dry mixing process is described in more detail in a co-pending commonly-assigned U.S. patent application Ser. No. 11/116,882. This application is hereby incorporated by reference for all it discloses as if fully set forth herein, including all figures, tables, and claims.

It should also be noted that references to dry-blending, dry particles, and other dry materials and processes used in the manufacture of an active electrode material and/or film do not exclude the use of other than dry processes, for example, this may be achieved after drying of particles and films that may have been prepared using a processing aid, liquid, solvent, or the like.

A product obtained through a process like process 100 may be used to make an electrode film. The films may then be bonded to a current collector, such as a foil made from aluminum or another conductor. The current collector can be a continuous metal foil, metal mesh, or nonwoven metal fabric. The metal current collector provides a continuous electrically conductive substrate for the electrode film. The current collector may be pretreated prior to bonding to enhance its adhesion properties. Pretreatment of the current collector may include mechanical roughing, chemical pitting, and/or use of a surface activation treatment, such as corona discharge, active plasma, ultraviolet, laser, or high frequency treatment methods known to a person skilled in the art. In one implementation, the electrode films may be bonded to a current collector via an intermediate layer of conductive adhesive known to those skilled in the art.

In one implementation, a product obtained from process 100 may be mixed with a processing aid to obtain a slurry-like composition used by those skilled in the art to coat an electrode film onto a collector (i.e. a coating process). The slurry may be then deposited on one or both sides of a current collector. After a drying operation, a film or films of active electrode material may be formed on the current collector. The current collector with the films may be calendered one or more times to densify the films and to improve adhesion of the films to the current collector.

In one implementation, a product obtained from process 100 may be mixed with a processing aid to obtain a paste-like material. The paste-like material may be then be extruded, formed into a film, and deposited on one or both sides of a current collector. After a drying operation, a film or films of active electrode material may be formed on the current collector. The current collector with the dried films may be calendered one or more times to densify the films and to improve adhesion of the films to the current collector.

In yet another implementation, in a product obtained through the process 100 the binder particles may include thermoplastic or thermoset particles. A product obtained through the process 100 that includes thermoplastic or thermoset particles may be used to make an electrode film. Such a film may then be bonded to a current collector, such as a foil made from aluminum or another conductor. The films may be bonded to a current collector in a heated calendar apparatus. The current collector may be pretreated prior to bonding to enhance its adhesion properties. Pretreatment of the current collector may include mechanical roughing, chemical pitting, and/or use of a surface activation treatment, such as corona discharge, active plasma, ultraviolet, laser, or high frequency treatment methods known to a person in the art.

Other methods of forming the active electrode material films and attaching the films to the current collector may also be used.

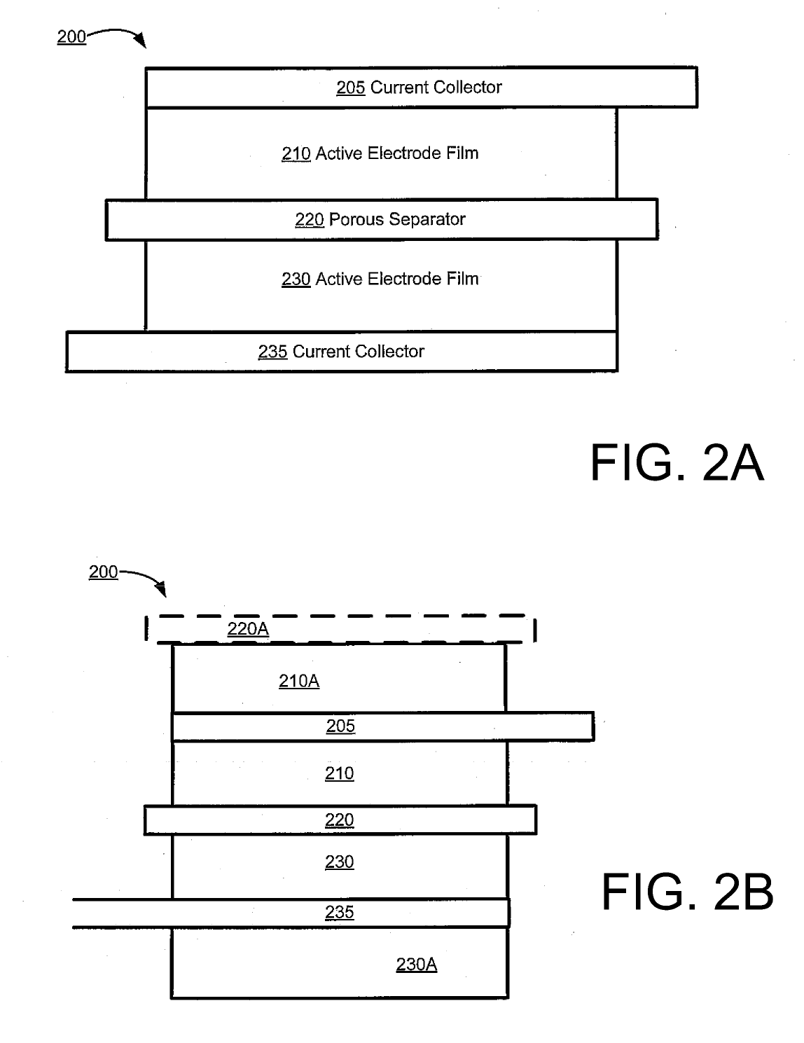

FIG. 2, including sub-part FIGS. 2A and 2B, illustrates, in a high level manner, respective cross-sectional views of an electrode assembly 200 which may be used in an ultracapacitor or a double layer capacitor. In FIG. 2A, the components of the assembly 200 are arranged in the following order: a first current collector 205, a first active electrode film 210, a porous separator 220, a second active electrode film 230, and a second current collector 235. In some implementations, a conductive adhesive layer (not shown) may be disposed on current collector 205 prior to bonding of the electrode film 210 (or likewise on collector 235 relative to film 230). In FIG. 2B, a double layer of films 210 and 210A are shown relative to collector 205, and a double layer 230, 230A relative to collector 235. In this way, a double-layer capacitor may be formed, i.e., with each current collector having a carbon film attached to both sides. A further porous separator 220A may then also be included, particularly for a jellyroll application, the porous separator 220A either attached to or otherwise disposed adjacent the top film 210A, as shown, or to or adjacent the bottom film 230A (not shown). The films 210 and 230 (and 210A and 230A, if used) may be made using particles of active electrode material obtained through the process 100 described in relation to FIG. 1. An exemplary double layer capacitor using the electrode assembly 200 may further include an electrolyte and a container, for example, a sealed can, that holds the electrolyte. The assembly 200 may be disposed within the container (can) and immersed in the electrolyte. In many implementations, the current collectors 205 and 235 may be made from aluminum foil, the porous separator 220 may be made from one or more ceramics, paper, polymers, polymer fibers, glass fibers, and the electrolytic solution may include in some examples, 1.5 M tetramethylammonium tetrafluoroborate in organic solutions, such as PC or Acetronitrile solvent. Alternative electrolyte examples are set forth below.

Following are several non-limiting examples of aqueous electrolytes which may be used in double-layer capacitors or ultracapacitors hereof: 1-molar Sodium sulphate, Na₂SO₄; 1-molar Sodium perchlorate, NaClO₄; 1-molar Potassium hydroxide, KOH; 1-molar Potassium chloride, KCl; 1-molar Perchloric acid, HClO₄; 1-molar Sulfuric acid, H₂SO₄; 1-molar Magnesium chloride, MgCl₂; and, Mixed aqueous 1-molar MgCl₂/H₂O/Ethanol. Some non-limitative nonaqueous aprotic electrolyte solvents which can be used in capacitors include: Acetonitrile; Gamma-butyrolactone; Dimethoxyethane; N,N,-Dimethylformamide; Hexamethyl-phosphorotriamide; Propylene carbonate; Dimethyl carbonate; Tetrahydrofuran; 2-methyltetra-hydrofuran; Dimethyl sulfoxide; Dimethyl sulfite; Sulfolane (tetra-methylenesulfone); Nitromethane; and, Dioxolane. Further, some non-limiting examples of electrolyte salts which can be used in the aprotic solvents include: Tetraalkylammonium salts (such as: Tetraethylammonium tetrafluoroborate, (C₂H₅)₄NBF₄; Methyltriethylammonium tetrafluoroborate, (C₂H₅)₃CH₃NBF₄; Tetrabutylammonium tetrafluoroborate, (C₄H₉)₄NBF₄; and, Tetraethylammonium hexafluorophosphate (C₂H₅)NPF₆); Tetraalkylphosphonium salts (such as: Tetraethylphosphonium tetrafluoroborate (C₂H₅)₄PBF₄; Tetrapropylphosphonium tetrafluoroborate (C₃H₇)₄PBF₄; Tetrabutylphosphonium tetrafluoroborate (C₄H₉)₄PBF₄; Tetrahexylphosphonium tetrafluoroborate (C₆H₁₃)₄PBF₄; Tetraethylphosphonium hexafluorophosphate (C₂H₅)₄PPF₆; and, Tetraethylphosphonium trifluoromethylsulfonate (C₂H₅)₄PCF₃SO₃; and Lithium salts (such as: Lithium tetrafluoroborate LiBF₄; Lithium hexafluorophosphate LiPF₆; Lithium trifluoromethylsulfonate LiCF₃SO₃). Additionally, some Solvent free ionic liquids which may be used include: 1-ethyl-3-methylimidazolium bis(pentafluoroethylsulfonyl) imide EMIMBeTi; 1-ethyl-3-methylimidazolium bis(trifluoromethylsulfonyl imide EMIMIm; EMIIm; EMIBeti; EMIMethide; DMPIIm; DMPIBeti; DMPIMethide; BMIIm; BMIBeti; BMIMethide; PMPIm; and, BMPIm. Examples for use as Anions include: bis(trifluoromethylsulfonyl)imide (CF₃SO₂)₂N⁻; bis(perfluoroethylsulfonyl)imide (C₂F₅SO₂)₂N⁻; and, tris(trifluoromethylsulfonyl)methide (CF₃SO₂)₃C⁻. And, examples for use as Cations include: EMI: 1-ethyl-3-methylimidazolium; DMPI: 1,2-dimethyl-3-propylimidazolium; BMI: 1-butyl-3-methylimidazolium; PMP: 1-N-propyl-3-methylpyridinium; and, BMP: 1-N-butyl-3-methylpyridinium.

Electrode products that include an active electrode film attached to a current collector and/or a porous separator may be used in an ultracapacitor or a double layer capacitor and/or other electrical energy storage devices.

In some implementations using a process 100, wherein activated carbon with no more than about 20 ppm or in some cases no more than about 10 ppm of iron is used, a high performance ultracapacitor or double-layer capacitor product can be provided. Such a product further may include about 10 percent by weight binder, and about 0.5 percent by weight conductive carbon.

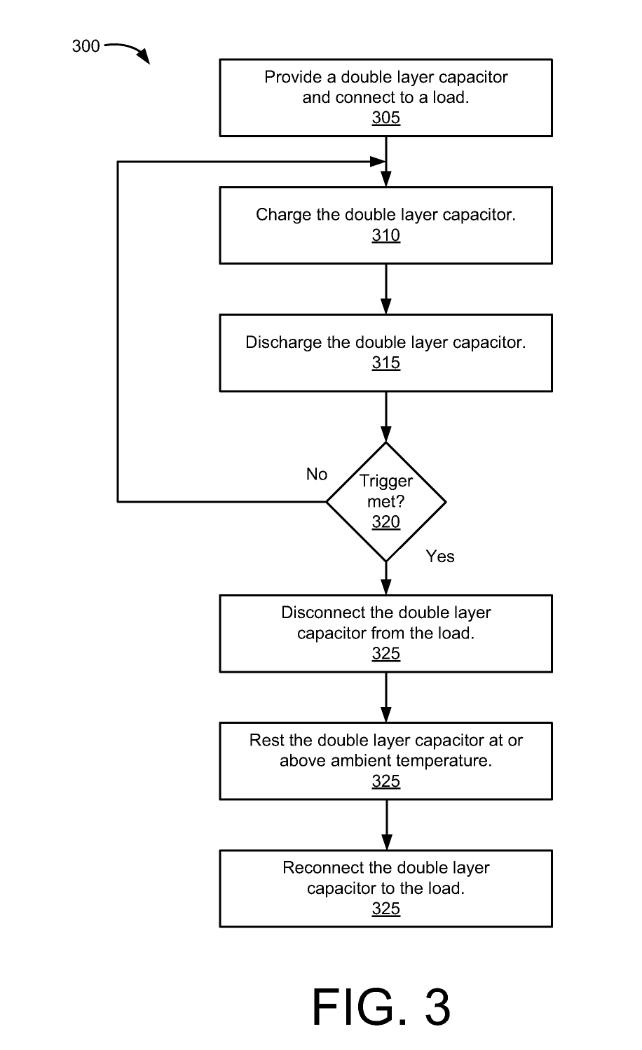

FIG. 3 shows a flow chart of an example process 300 for recovering capacitance in a double layer capacitor. In this process, the double layer capacitor is provided and connected to an electrical device in operation 305. The double layer capacitor is charged in operation 310 and discharged in operation 315. Operations 310 and 315 are repeated until a trigger is met in operation 320. The trigger may be any trigger that may be used to indicate that a recovery of capacitance may be desired. The trigger, for example, may comprise a predetermined number of charge/discharge cycles, an approximate number of charge discharge times, a determination that a capacitance level has faded a predetermined amount or percent, a predetermined or approximate duration of time, or any other factor.

After the trigger has been met, the double layer capacitor is disconnected from the electrical device in operation 325. The double layer capacitor undergoes a rest operation 330 during which time the capacitance of the capacitor recovers from the fade that has occurred during the charge/discharge cycles. The rest operation 330 may occur at about ambient temperature or greater. The double layer capacitor, for example, may be rested at room temperature or may be rested in an oven at an elevated temperature. In one embodiment, for example, the oven may be set to a temperature of 85 degrees Celsius for a period of about 24 to 48 hours. The double layer capacitor is then reconnected to the electrical device with a recovered capacitance in operation 335. The increase in capacitance increases the available energy storage capacity of the double layer capacitor. Also, the reduced capacitance fade results in a longer lifetime of the double layer capacitor since the capacitance remains within a target area (e.g., at least 70% of its rated capacitance) for a longer time period.

### EXAMPLE 1

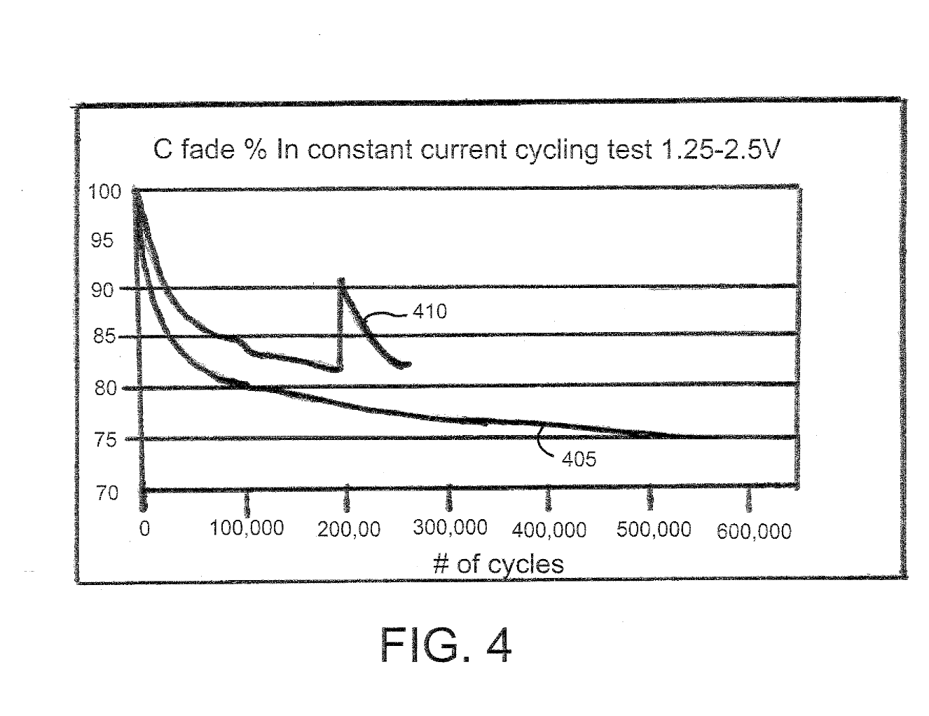

FIG. 4 shows a graph 400 of data taken from a double layer capacitor showing a percent of capacitance fade on a vertical axis and a number of cycles on a horizontal axis. A baseline 405 capacitance curve for a double layer capacitor cell is shown. The baseline 405 shows a predicted capacitance fade versus a number of charge/discharge cycles for the double layer capacitor cell. As can be seen in FIG. 4, the predicted capacitance level shown by the baseline 405 begins at 100% and drops as the number of charge/discharge cycles increases. The capacitance will continue to fade until the capacitance of the cell drops to a level that is unacceptable for a particular application.

An example of data for an MC2600 double layer capacitor cell 410 available from Maxwell Technologies, Inc. of San Diego, Calif. 92444 put through a number of charge/discharge cycles and the capacitance change was tracked for these cycles. A capacitance drop for the 022105-327 MC2600 double layer capacitor cell 410 of approximately 17% was reached after 200,000 charge/discharge cycles. After 200,000 cycles, the double layer capacitor cell 410 was disconnected from its load and rested at room temperature for about two weeks. After the two week rest, the 022105-327 MC2600 double layer capacitor cell 410 achieved approximately a 10% capacitance recovery. Alternatively, the cell could be placed in an oven (e.g., at 85 C) for approximately one to two days to achieve a similar capacitance recovery.

### EXAMPLE 2

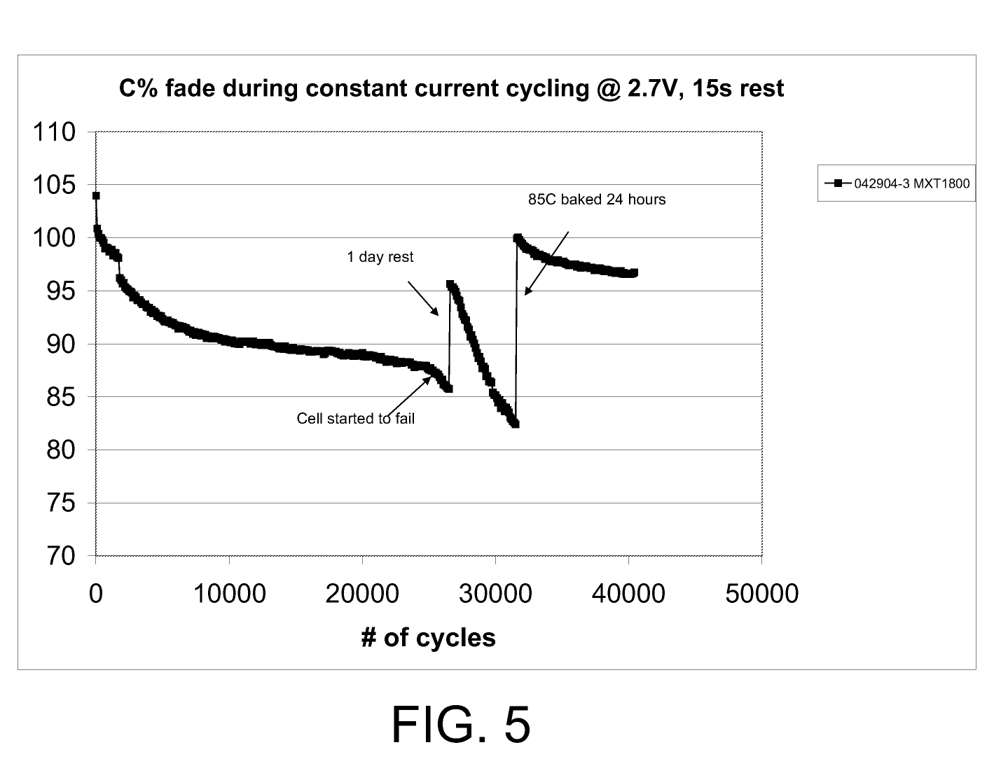

FIG. 5 shows a graph 500 of data taken for another double layer capacitor showing a percent of capacitance fade on a vertical axis and a number of cycles on a horizontal axis. In this example, a capacitance of an MXT 1800 double layer capacitor cell 510 decreases from approximately 100 percent of a rated capacitance until the cell started to fail for a particular application at a loss of capacitance of about 15% below its rated capacitance. The double layer capacitor cell 510 was then disconnected and allowed to rest at room temperature for about 24 hours. After the rest period, the double layer capacitor cell 510 was reconnected in the electrical circuit and showed an increased capacitance level above 95% of its rated capacitance. Thus, the rest period allowed the double layer capacitor cell 510 to regain a portion of its lost capacitance. As the double layer capacitor cell 510 underwent further charge/discharge cycles, the capacitance again faded to about 83% of its rated capacitance. The double layer capacitor cell 510 was again disconnected and placed in an 85 C oven and baked for 24 hours. When the double layer capacitor cell 510 was removed from the oven and reconnected, the capacitance of the capacitor had recovered to approximately 100% of its rated capacitance.

### EXAMPLE 3

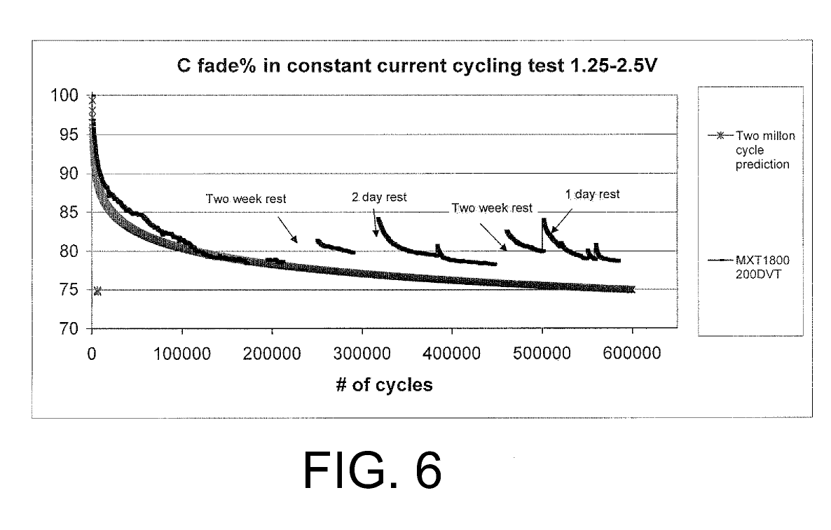

FIG. 6 shows a graph 600 of data taken for another double layer capacitor showing a percent of capacitance fade on a vertical axis and a number of cycles on a horizontal axis. In this example, a baseline 405 capacitance curve for a double layer capacitor cell is shown. The baseline 405 shows a predicted capacitance fade versus a number of charge/discharge cycles for the double layer capacitor cell. As can be seen in FIG. 6, the predicted capacitance level shown by the baseline 405 begins at 100% and drops as the number of charge/discharge cycles increases. The capacitance will continue to fade until the capacitance of the cell drops to a level that is unacceptable for a particular application.

An example of data for another MXT 1800 double layer capacitor cell 610 available from Maxwell Technologies, Inc. of San Diego, Calif. 92444 put through a number of charge/discharge cycles and the capacitance change was tracked for these cycles. A capacitance drop for the cell 610 of approximately 22% was reached after about 200,000 charge/discharge cycles. After about 200,000 cycles, the double layer capacitor cell 610 was disconnected from its load and rested at room temperature for about two weeks. After the two week rest, the double layer capacitor cell 610 achieved approximately a 4% capacitance recovery to about 82 percent of its rated capacitance as shown in FIG. 6. The double layer capacitor cell 610 was then reconnected and cycled through additional charge/discharge cycles. During these charge/discharge cycles, the capacitance of the cell 610 again faded to below about 80% of its rated capacitance. The cell 610 was again disconnected and rested at room temperature for about two days. After this rest period, the cell 610 had recovered its capacitance level to about 84% of its rated capacitance as shown in FIG. 6. The cell 610 was reconnected and underwent additional charge/discharge cycles until the capacitance level dropped to about 78% of its rated capacitance. The cell 610 was then disconnected and rested at room temperature for approximately two weeks. After the rest, the capacitance of the cell 610 had again recovered to about 83% of its rated capacitance. The cell 610 was again reconnected and underwent charge/discharge cycles until its capacitance had faded to about 80% of its rated capacitance level after approximately 500,000 cycles. The cell 610 was once again disconnected and rested at room temperature for approximately one day, during which time the cell 610 recovered to about 84% of its rated capacitance level. Again, the cell could alternatively be placed in an oven (e.g., at about 85 C) to achieve a similar capacitance recoveries.

Different double layer capacitors may experience different capacitance fade and/or recovery profiles based upon a particular application or structure. Double layer capacitors having longer electrodes, for example, may experience greater capacitance decay than double layer capacitors having shorter electrodes. Thus, in cells having longer electrodes, capacitance recovery may be greater compared to capacitance recovery levels for double layer capacitor cells having shorter electrode lengths. This may be due to electrolyte travel distances where the capacitance fade is affected by local electrolyte starvation during charge and discharge cycles.

The inventive methods for making active electrode material, films of these materials, electrodes made with the films, and double layer capacitors employing the electrodes have been described above in considerable detail. This was done for illustrative purposes. Neither the specific implementations of the invention as a whole, nor those of its features, limit the general principles underlying the invention. In particular, the invention is not necessarily limited to the specific constituent materials and proportions of constituent materials used in making the electrodes. In addition, example methods are disclosed. One skilled in the art would be able to vary these methods based upon this disclosure for varying double layer capacitor characteristics (e.g., size, capacitance, electrical characteristics, or other variations). The specific features described herein may be used in some implementations, but not in others, without departure from the spirit and scope of the invention as set forth. Many additional modifications are intended in the foregoing disclosure, and it will be appreciated by those of ordinary skill in the art that, in some instances, some features of the invention will be employed in the absence of other features. The illustrative examples therefore do not define the metes and bounds of the invention and the legal protection afforded the invention, which function is served by the claims and their equivalents.

What is claimed is:

1. A method of recovering a capacitance of a double layer capacitor product, the method comprising:
providing a double layer capacitor;
repeatedly charging the double layer capacitor and discharging the double layer capacitor, wherein the repeated charge and discharge cycles provide a decrease in a capacitance of the double layer capacitor;
resting the double layer capacitor at or above ambient temperature to recover at least a portion of the decreased capacitance; and
recharging the double layer capacitor.

2. A method in accordance with claim 1, wherein resting operation occurs at about ambient temperature.

3. A method in accordance with claim 1, wherein the resting operation occurs in an oven at a temperature greater than ambient temperature.

4. A method in accordance with claim 3, wherein the resting operation occurs in the oven at a temperature of about 85 degrees Celsius.

5. A method in accordance with claim 1, wherein the double layer capacitor comprises an electrode comprising activated carbon and binder.

6. A method in accordance with claim 5, wherein the electrode further comprises conductive carbon.

7. A method in accordance with claim 1, wherein the operation of resting the double layer capacitor provides an increased lifetime of the double layer capacitor.
